(19) United States
(12) Patent Application Publication
(10) Pub. No.: US 2024/0291016 A1
(43) Pub. Date: Aug. 29, 2024

(54) BATTERY ELECTRODE MANUFACTURING DEVICE AND BATTERY ELECTRODE MANUFACTURING METHOD

(71) Applicant: APB CORPORATION, Tokyo (JP)

(72) Inventors: Hideaki HORIE, Tokyo (JP); Kenichiro ENOKI, Kyoto (JP); Yusuke NAKASHIMA, Kyoto (JP)

(21) Appl. No.: 18/573,466

(22) PCT Filed: Jun. 23, 2022
(86) PCT No.: PCT/JP2022/025201

§ 371 Date: Dec. 22, 2023

(30) Foreign Application Priority Data
Jun. 23, 2021 (JP) 2021-104010
Jun. 23, 2021 (JP) 2021-104011
Jun. 23, 2021 (JP) 2021-104052

(51) Int. Cl. H01M 10/04

(52) U.S. Cl. CPC H01M 10/0468; H01M 10/0404

(57) ABSTRACT

The battery electrode manufacturing device comprises: a film supply unit that supplies a film to an active material, wherein the active material has been stacked on a strip-shaped base film, wherein the active material is conveyed along a conveying direction in a chamber whose interior is decompressed below atmospheric pressure; and a compression unit that compresses the active material, which has been supplied on the base film, via the film.

### FIELD OF THE INVENTION

This invention relates to a battery electrode manufacturing device and a battery electrode manufacturing method.

### BACKGROUND ART

Lithium-ion batteries are high-capacity secondary batteries and have come to be widely used in a variety of usages. For example, a lithium-ion battery comprises a plurality of single cells in which a current collector layer, an active material layer, and a separator, are stacked. Such a single cell can be manufactured in the form of a single sheet, for example, as described in Patent Document 1 and Patent Document 2. Specifically, as described in Patent Document 2, battery electrodes for a single cell can be individually manufactured by stacking a current collector, an active material, and a separator and performing surface pressing. However, such a single-sheet method generally takes time and cannot be said to have high manufacturing efficiency.

From the viewpoint of improving manufacturing efficiency, it is conceivable to manufacture battery electrodes continuously. For example, it is conceivable that an active material layer of a battery electrode can be efficiently formed by continuously supplying an active material to a strip-shaped base film (such as a current collector) and continuously roll-pressing them.

### CITATION LIST

### Patent Literature

[Patent Reference 1] Publication of Japanese Patent No. 6633866
[Patent Reference 2] Japanese Unexamined Patent Application Publication No. 2019-186003
[Patent Reference 3] Japanese Unexamined Patent Application Publication No. 2001-176482

### BRIEF SUMMARY OF THE INVENTION

### Problems that Invention is to Solve

In a case when compressing an active material using a roll press, the active material may adhere to the surface of the roller of the roll press. If the active material adheres to the roller surface during compression, there would be concern that the surface of the formed active material layer will become uneven or that the amount of active material in the battery electrode will become unstable.

The present invention has an objective to provide a battery electrode manufacturing device and a battery electrode manufacturing method that can improve manufacturing efficiency and quality of battery electrodes.

### Means to Solve the Problems

In order to achieve the objective, a battery electrode manufacturing device of this invention comprises: a film supply unit that supplies a film to an active material, wherein the active material has been stacked on a strip-shaped base film, wherein the active material is conveyed along a conveying direction in a chamber whose interior is decompressed below atmospheric pressure; and a compression unit that compresses the active material, which has been supplied on the base film, via the film.

### Effects of the Invention

The battery electrode manufacturing device and the battery electrode manufacturing method of this invention can improve manufacturing efficiency and quality of battery electrodes.

### BRIEF DESCRIPTION OF DRAWINGS

FIG. 1 is a schematic cross-sectional diagram of a single cell, which is manufactured by a battery electrode manufacturing device of the first embodiment.

FIG. 2 is a schematic diagram showing the battery electrode manufacturing device.

FIG. 3 is a perspective diagram showing the battery electrode manufacturing device.

FIG. 4 is a perspective diagram showing a battery electrode manufacturing device of the second embodiment.

FIG. 5 is a schematic diagram showing a separator soaked with an electrolytic solution according to the second embodiment.

FIG. 6 is a schematic diagram showing the battery electrode manufacturing device of the third embodiment.

FIG. 7 is a diagram showing a compression device included in the battery electrode manufacturing device of the third embodiment.

FIG. 8 is a diagram showing a reinforcing sheet according to the third embodiment.

FIG. 9 is a diagram showing a compression device and a high-precision compression device included in the battery electrode manufacturing device of the third embodiment.

FIG. 10 is a schematic diagram showing the battery electrode manufacturing device of the fourth embodiment.

FIG. 11 is an example diagram showing a combining device of the battery electrode manufacturing device of the fourth embodiment.

### DESCRIPTION OF EMBODIMENTS

### First Embodiment

Hereinafter, a first embodiment to which the present invention is applied will be described with reference to the figures. Herein, in the figures used in the following explanation, characteristic portions may be shown enlarged for the purpose of emphasizing the characteristic portions for convenience. And the dimensional ratio of each component is not necessarily the same as the real component. Further, for the same purpose, some components may be omitted from the illustration.

### <Assembled Battery (Secondary Battery)>

The battery electrode manufacturing device and the battery electrode manufacturing method of the embodiment are applied, for example, to the manufacture of lithium-ion batteries. Lithium-ion batteries can be used, for example, in the form of a battery pack whose voltage and capacity can be adjusted with an assembled battery that is made into a module by combining lithium-ion cells (also written as single cell or battery cell) or by combining multiple such assembled batteries.

### <Single Cell (Battery Cell)>

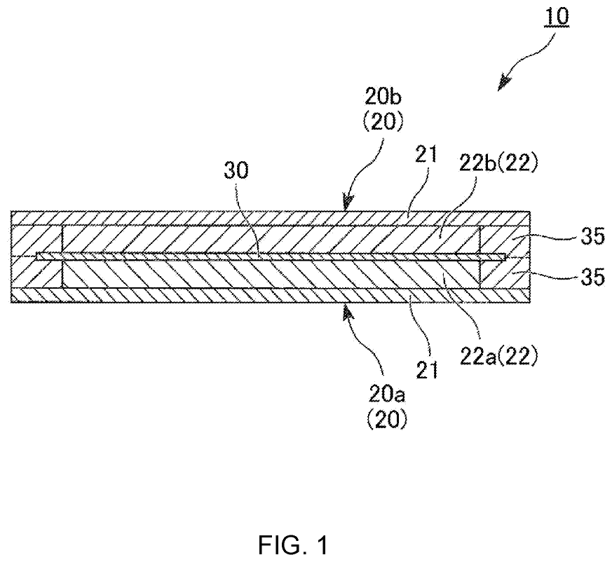

FIG. 1 is a schematic cross-sectional view of a single cell 10. It is possible to produce the above assembled battery by combining a plurality of single cells 10. For example, the single cell 10 comprises a cathode 20a and an anode 20b as two electrodes (battery electrodes), and a separator 30.

The separator 30 is arranged between the cathode 20a and the anode 20b. In terms of the assembled battery, a plurality of single cells 10 are stacked where the cathode 20a and the anode 20b are facing at the same direction.

The separator 30 holds an electrolyte. Thereby, the separator 30 functions as an electrolyte layer. The separator 30 is arranged between the electrode active material layers 22 of the cathode 20a and the anode 20b, and prevents them from contacting with each other. Thereby, the separator 30 functions as a partition between the cathode 20a and the anode 20b.

Examples of the electrolyte held in the separator 30 include an electrolytic solution or a gel polymer electrolyte. The separator 30 ensures high lithium-ion conductivity by using these electrolytes. Examples of the form of the separator include a porous sheet separator made of a polymer or fiber that absorbs and retains the electrolyte, a nonwoven fabric separator, and the like.

The cathode 20a and the anode 20b each comprise a current collector 21, an electrode active material layer 22, and a frame member 35. The electrode active material layer 22 and the current collector 21 are arranged in this order from the separator 30 side. The frame member 35 is frame-shaped (annular). The frame member 35 surrounds the electrode active material layer 22. The frame member 35 of the cathode 20a and the frame member 35 of the anode 20b are welded together and integrated. In the following description, when the electrode active material layers 22 of the cathode 20a and the anode 20b are to be distinguished from each other, they will be referred to as a cathode active material layer 22a and an anode active material layer 22b, respectively.

### <Specific Example of Cathode Current Collector>

As the cathode current collector constituting the cathode current collector layer 21a, a current collector used in a known lithium-ion cell can be used. For example, as the cathode current collector, a known metal current collector and a resin current collector composed of a conductive material and a resin (resin current collector described in JP 2012-150905 and WO 2015/005116, etc.), can be used. The cathode current collector constituting the cathode current collector layer 21a is preferably a resin current collector from the viewpoint of battery characteristics and the like.

Examples of metal current collectors include copper, aluminum, titanium, nickel, tantalum, niobium, hafnium, zirconium, zinc, tungsten, bismuth, antimony, alloys containing one or more of these metals, and one or more metal materials selected from the group consisting of stainless steel alloys. These metal materials may be used in the form of a thin plate, metal foil, or the like. Furthermore, a substrate, which is made of a material other than the above-described metal material, on which the above-mentioned metal material is formed by sputtering, electrodeposition, coating or the like, may be used as the metal current collector.

The resin current collector preferably contains a conductive filler and a matrix resin. Examples of the matrix resin include polyethylene (PE), polypropylene (PP), polymethylpentene (PMP), etc., but are not particularly limited. The conductive filler is not particularly limited as long as it is selected from materials having conductivity. The conductive filler may be a conductive fiber having a fibrous shape.

The resin current collector may contain other components (dispersant, crosslinking accelerator, crosslinking agent, coloring agent, ultraviolet absorber, plasticizer, etc.) in addition to the matrix resin and the conductive filler. Further, a plurality of resin current collectors may be stacked and used, or a resin current collector and a metal foil may be stacked and used.

The thickness of the cathode current collector layer 21a is not particularly limited, but is preferably 5 to 150 μm. When a plurality of resin current collectors are stacked and used as the cathode current collector layer 21a, the total thickness after stacking is preferably 5 to 150 μm. The cathode current collector layer 21a can be obtained, for example, by molding a conductive resin composition obtained by melt-kneading a matrix resin, a conductive filler, and an optional filler dispersant into a film-shaped composition by a known method.

### <Specific Examples of Cathode Active Materials>

The cathode active material layer 22a is preferably a non-bound body of a mixture containing the cathode active material. Herein, a non-bound body means that the position of the cathode active material in the cathode active material layer is not fixed, and the cathode active materials and the cathode active materials and the cathode active material and the current collector are irreversibly fixed from each other. When the cathode active material layer 22a is a non-bound body, since the cathode active materials are not irreversibly fixed to each other, the interface between the cathode active materials can be separated without mechanical damages. Therefore, even when stress is applied to the cathode active material layer 22a, the transfer of the cathode active material can prevent destruction of the cathode active material layer 22a, which is preferable. The cathode active material layer 22a, which is a non-bound body, can be obtained by a method of changing the cathode active material layer 22a to the cathode active material layer 22a that contains a cathode active material and an electrolytic solution, and that does not contain a binder. Here, in this specification, the binder refers to an agent that cannot reversibly fix the cathode active material to each other and the cathode active material to the current collector, and known solvent-drying type binders for lithium ion batteries such as starch, polyvinylidene fluoride, polyvinyl alcohol, carboxymethyl cellulose, polyvinylpyrrolidone, tetrafluoroethylene, styrene-butadiene rubber, polyethylene and polypropylene may be exemplified. These binders are used by being dissolved or dispersed in a solvent, and are solidified by volatilizing and distilling off the solvent without the surface becoming sticky. Therefore, it is not possible to reversibly fix the cathode active materials, or the cathode active material and the current collector.

Examples of the cathode active material include a composite oxide of lithium and a transition metal, a composite oxide having two kinds of transition metal elements, a composite oxide having three or more kinds of metal elements and the like, but are not particularly limited.

The cathode active material may be a coated cathode active material in which at least a part of the surface is covered with a coating material containing a polymer compound. When the outer periphery of the cathode active material is covered with a coating material, volume change of the cathode is alleviated, and expansion of the cathode can be suppressed.

As the polymer compound constituting the coating material, those described as a resin for coating active material mentioned in JP 2017-054703 and WO 2015/005117 can be suitably used.

The coating material may contain a conductive assistant. As the conductive assistant, the same conductive filler contained in the cathode current collector layer 21a, can be suitably used.

The cathode active material layer 22a may contain adhesive resin. As the adhesive resin, those described as a mixture of a resin for coating non-aqueous secondary battery active materials, which is mentioned in Japanese Unexamined Patent Application, First Publication No. 2017-054703, and a small amount of organic solvent with adjusting the glass transition temperature below room temperature, and as an adhesive resin mentioned in Japanese Unexamined Patent Application, First Publication No. H10-255805 or the like, can be used. Here, the adhesive resin means a resin having pressure-sensitive adhesiveness (an adhering property obtained by applying a slight pressure without using water, solvent, heat, or the like) without solidifying even in a case where a solvent component is volatilized and dried. On the other hand, a solution-drying type binder for an electrode, which is used as a binding material, means a binder that dries and solidifies in a case where a solvent component is volatilized, thereby firmly adhering and fixing active materials to each other. As a result, the binder (the solution-drying type electrode binder) and the adhesive resin are different materials.

The cathode active material layer 22a may contain an electrolytic solution that contains an electrolyte and a non-aqueous solvent. As the electrolyte, those used in the known electrolytic solution can be used. As the non-aqueous solvent, those used in known electrolytic solutions (for example, phosphoric acid esters, nitrile compounds, etc., mixtures thereof, etc.) can be used. For example, a mixture of ethylene carbonate (EC) and dimethyl carbonate (DMC) or a mixture of ethylene carbonate (EC) and propylene carbonate (PC) can be used.

The cathode active material layer 22a may contain a conductive assistant. As the conductive assistant, a conductive material similar to the conductive filler contained in the cathode current collector layer 21a, can be suitably used.

The thickness of the cathode active material layer 22a is not particularly limited, but from the viewpoint of battery performance, it is preferably 150 to 600 μm, more preferably 200 to 450 μm.

### <Specific Example of Anode Current Collector>

As the anode current collector constituting the anode current collector layer 21b, one having the same structure as that described for the cathode current collector can be appropriately used. It also can be obtained by the same method. The anode current collector layer 21b is preferably a resin current collector from the viewpoint of battery characteristics and the like. The thickness of the anode current collector layer 21b is not particularly limited, but is preferably 5 to 150 μm.

### <Specific Examples of Anode Active Materials>

It is preferable that the anode active material layer 22b is a non-bound body of a mixture containing the anode active material. The reason why it is preferable that the anode active material layer is a non-bound body, is the same reason why it is preferable that the cathode active material layer 22a is a non-bound body. The method of obtaining the anode active material layer 22b which is a non-bound body, is the same as the method of obtaining the cathode active material layer 22a which is a non-bound body.

As the anode active material, for example, carbon-based materials, silicon-based materials, and mixtures thereof can be used, but there is no particular limitation.

The anode active material may be a coated anode active material, where at least a part of a surface of the coated anode active material is coated with a coating material containing a macromolecule compound. In a case where the outer periphery of the anode active material is covered by a coating material, the volume change of the anode is alleviated, and thus the expansion of the anode can be suppressed.

As the coating material, the same one as the coating material constituting the coated cathode active material can be suitably used.

The anode active material layer 22b contains an electrolyte and an electrolytic solution that contains a non-aqueous solvent. Regarding the composition of the electrolytic solution, an electrolytic solution similar to that contained in the cathode active material layer 22a can be suitably used.

The anode active material layer 22b may contain a conductive assistant. As the conductive assistant, a conductive material similar to the conductive filler contained in the cathode active material layer 22a can be suitably used.

The anode active material layer 22b may contain adhesive resin. As the adhesive resin, the same adhesive resin as the optional component of the cathode active material layer 22a can be suitably used.

The thickness of the anode active material layer 22b is not particularly limited, but from the viewpoint of battery performance, it is preferably 150 to 600 μm, more preferably 200 to 450 μm.

### <Specific Example of Separator>

Examples of the electrolyte held in the separator 30 include an electrolytic solution or a gel polymer electrolyte. The separator 30 ensures high lithium-ion conductivity by using these electrolytes. The form of the separator 30 includes, for example, a porous film made of polyethylene or polypropylene, but is not particularly limited.

### <Specific Example of Frame Member>

The frame member 35 is not particularly limited as long as it is made of a material that is durable against the electrolytic solution, but a polymer material is preferable, and a thermosetting polymer material is more preferable. The material constituting the frame member 35 may be any material as long as it has insulation properties, sealing properties (liquid tightness), heat resistance under the battery operating temperature, etc., and a resin material is suitably selected. Specifically, epoxy resins, polyolefin resins, polyester resins, polyurethane resins, polyvinidene fluoride resins, etc. may be used for the frame member 35.

### <Manufacturing Device and Battery Electrode Manufacturing Method>

Next, a manufacturing device and a battery electrode manufacturing method (hereinafter simply referred to as a manufacturing method) of the present embodiment, will be described. For example, as for the battery manufacturing device and manufacturing method, first, the cathode 20a and the anode 20b are manufactured. The manufacturing method for the cathode 20a and the manufacturing method for the anode 20b differ mainly in the electrode active material contained in the electrode active material layer 22. Herein, as a manufacturing method for the electrode 20, the manufacturing method for the cathode 20a and the anode 20b will be described together.

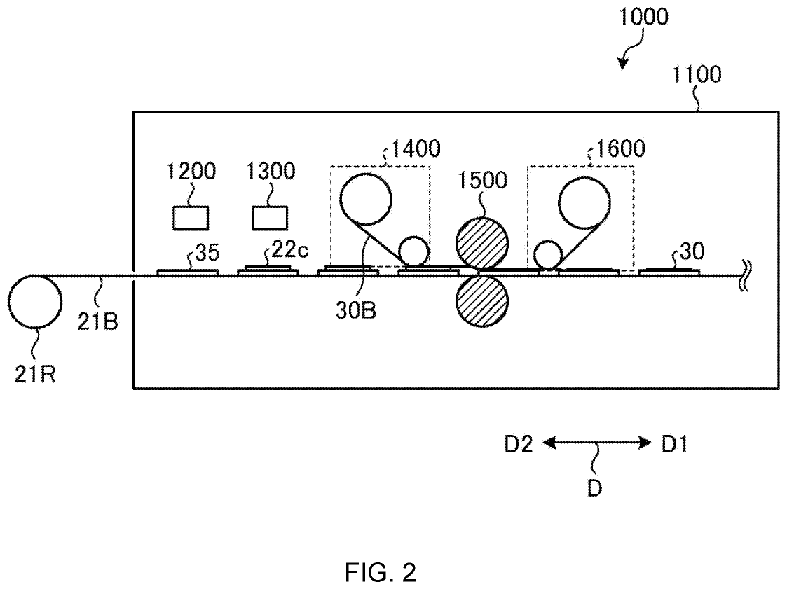

FIG. 2 is a schematic diagram showing the manufacturing device 1000. For example, the manufacturing device 1000 comprises a chamber 1100, a frame member supply device 1200, an active material supply device 1300, a separator supply device 1400, a roller 1500, and a separator collecting device 1600. The separator supply device 1400 is an example of a separator supply unit and an example of a film supply unit. The roller 1500 is an example of a compression section.

The chamber 1100 functions as a room in which the inside space can be maintained at a pressure lower than the atmospheric pressure. The inside of the chamber 1100 is decompressed below atmospheric pressure by a decompress pump, which is not shown in the figure. The standard atmospheric pressure is approximately 1013 hPa (approximately 10⁵ Pa).

For example, a current collector roll 21R is arranged outside of the chamber 1100, and a strip-shaped current collector 21B pulled out from the current collector roll 21R is conveyed into the chamber 1100 through a slit. Note that the current collector 21B is the current collector 21 before being cut into a predetermined shape. The current collector 21B is conveyed along the conveying direction D. For example, the current collector 21B is conveyed at a predetermined speed by a conveying device such as a belt conveyor. In the following description, the direction in which the current collector 21B is referred to as the downstream side D1, and the opposite direction is referred to as the upstream side D2. Note that the external space of the chamber 1100 in which the current collector roll 21R may be arranged at a normal pressure or may be reduced in pressure by a chamber, which is different from the chamber 1100.

The frame member supply device 1200 supplies the frame member 35 to the current collector 21B being conveyed. Note that although FIG. 2 shows a case where the frame member supply device 1200 is arranged inside the chamber 1100, the frame member supply device 1200 may be arranged outside the chamber 1100. For example, the frame member supply device 1200 has a robot arm and places the frame member 35, which has been manufactured in advance, at a predetermined position on the current collector 21B being conveyed. Note that after the frame member 35 is placed on the current collector 21B, the current collector 21B and the frame member 35 may be compressed using a roll press, which is different from the roller 1500, so as to sandwich the current collector 21B and the frame member 35.

Note that the method for manufacturing the frame member 35 is not particularly limited. For example, the frame member 35 can be formed into a predetermined shape by cutting a sheet or block made of a predetermined material such as a polymeric material. For example, the frame member 35 is obtained by punching out a material sheet made of a predetermined material.

Further, for example, the frame member 35 can be formed into a predetermined shape by a method using a frame mold such as injection molding. For example, a mold having an internal space of a predetermined shape is prepared in advance and the frame member 35 can be formed into the predetermined shape by performing injection molding on the mold.

Further, for example, the frame member 35 can be formed into a predetermined shape by discharging or applying a predetermined material onto the substrate. For example, the frame member 35 can be formed into a predetermined shape by a dispenser. The frame member 35 can be formed by discharging a predetermined amount of a predetermined material from a nozzle onto a substrate under the control of a dispenser. For example, the frame member 35 can also be formed by applying a predetermined material onto a substrate in a predetermined shape using a coater such as a screen-printer.

More specifically, the frame member 35 can be formed by discharging or applying a predetermined material onto a substrate in a predetermined shape using a dispenser, coater, etc., and peeling it off from the substrate after drying. Alternatively, the frame member 35 can be formed by discharging or applying a predetermined material such as a two-component curing resin or a UV curing resin onto a substrate using a dispenser or a coater so as to have a predetermined shape, and peeling it off from the substrate after curing.

In addition, the frame member 35 can be formed into a predetermined shape using various methods. For example, the frame member 35 may be formed into a predetermined shape by assembling sheets or blocks made of a predetermined material so as to have a predetermined shape. Further, for example, the frame member 35 may be formed into a predetermined shape by arranging a sheet made of a predetermined material in the longitudinal direction of the substrate and discharging or applying the material in the vertical direction. Alternatively, the frame member 35 can also be manufactured using any type of 3D printer.

Furthermore, although the frame member 35, which has been manufactured in advance, is placed on the current collector 21B in FIG. 2, the embodiment is not limited thereto. For example, the frame member 35 may be manufactured on the current collector 21B. For example, in a case when the current collector 21B is used as a substrate, the frame member 35 can be formed on the current collector 21B by discharging or applying a predetermined material in a predetermined shape onto the current collector 21B using a dispenser, coater, etc.

As shown in FIG. 2, the active material supply device 1300 supplies the active material 22c onto the current collector 21B, which is conveyed in the chamber 1100. The active material 22c refers to a plurality of granulated electrode particles containing an electrode active material and a conductive assistant. For example, the active material supply device 1300 comprises a hopper that holds an active material therein and a shutter that opens and closes an opening of the hopper. The active material supply device 1300 can supply a desired amount of active material 22c to a desired position along the conveying direction D on the current collector 21B, which is conveyed, by opening and closing the shutter.

After each step shown in FIG. 2, the current collector layer 21 shown in FIG. 1 is formed by dividing the strip-shaped current collector 21B into predetermined units. The active material supply device 1300 manufactures a member sheet in which a plurality of members including the current collector layer 21 and the active material 22c are connected by supplying the active material 22c onto the current collector layer 21 (that is, the current collector 21B) before the current collector layer 21 is divided.

The separator supply device 1400 supplies the separator 30 to the member sheet. Specifically, the separator supply device 1400 supplies the separator 30 to the active material 22c, which has been stacked on the current collector 21B. For example, the separator supply device 1400 comprises a separator roll 30R and a drive mechanism that draws out the separator sheet 30B from the separator roll 30R. The separator supply device 1400 overlaps the active material 22c, which is conveyed at a predetermined speed along the conveying direction D, with the separator sheet 30B while conveying the separator sheet 30B at the same predetermined speed. More specifically, separator supply device 1400 comprises a roller, which is positioned above the member sheet, being conveyed as a drive mechanism. The separator supply device 1400 can supply the separator 30 to the active material 22c by pressing the separator sheet 30B against the member sheet using the roller while conveying the separator sheet 30B at a predetermined speed.

The roller 1500 forms the active material layer 22 shown in FIG. 1 by compressing the active material 22c, which has been supplied onto the current collector 21B. Specifically, the rollers 1500 sandwich and compress the member sheet and the separator 30 while the active material 22c is sandwiched between the current collector layer 21 and the separator 30. In other words, the roller 1500 compresses the active material 22c via the separator 30. As a result, among the single cell 10 shown in FIG. 1, a member consisting of one electrode 20 and the separator 30 is manufactured.

The separator collecting device 1600 collects the surplus portion of separator sheet 30B. In other words, the entire separator sheet 30B is not used as the separator 30 and there may be portions such as the ends of the separator sheet 30B that are not cut out as the separator 30. The separator collecting device 1600 collects such surplus portion. Note that if there is no surplus portion, the manufacturing device 1000 may not comprise the separator collecting device 1600.

As shown in FIG. 2, the manufacturing device 1000 can continuously manufacture the members of the single cell 10 including the current collector layer 21, the active material layer 22, the separator 30, and the frame member 35. In other words, the manufacturing device 1000 can continuously manufacture the electrodes 20 stacked with the separators 30. Further, as shown in FIG. 2, in terms of the manufacturing device 1000, the compression of the active material 22c is conducted while the separator 30 is sandwiched between the roller 1500 and the active material 22c. Therefore, the manufacturing device 1000 can prevent the active material 22c from adhering to the roller 1500. As a result, the manufacturing device 1000 can prevent the surface of the active material layer 22 formed by compression of the active material 22c from becoming uneven. Also, the manufacturing device 100 can prevent the amount of the active material 22c contained in the electrode 20 from becoming unstable. In conclusion, the manufacturing device 1000 can improve the manufacturing efficiency and quality of the electrode 20.

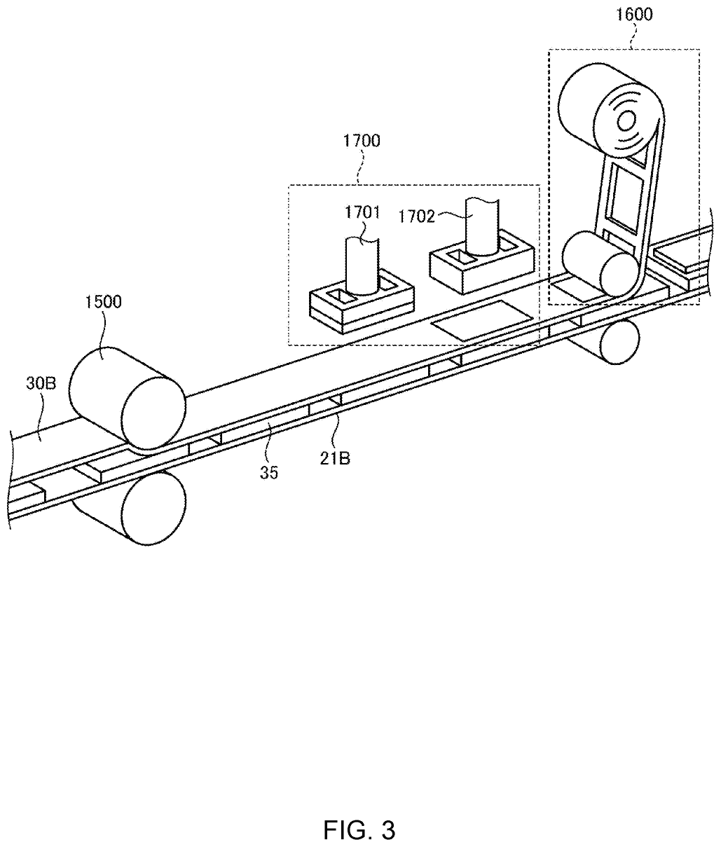

After the compression process by the rollers 1500, the manufacturing device 1000 may further perform various post-processing. For example, the manufacturing device 1000 comprises a post-processing device 1700 shown in FIG. 3. The post-processing device 1700 is an example of a post-processing section. In FIG. 3, a heat-sealing device 1701 and a shaping/cutting device 1702 are illustrated as the post-processing device 1700. The heat-sealing device 1701 heat-seals the separator 30 to the frame member 35. Further, the shaping/cutting device 1702 cuts out the separator 30 from the separator sheet 30B being conveyed.

Specifically, the heat-sealing device 1701 adheres to the separator sheet 30B to the frame member 35 by heating and pressurizing the edge of the portion, which is cut out as the separator 30 from the conveyed separator sheet 30B. Thereby, in the single cell 10, leakage of the electrolytic solution and the like from the gap between the separator 30 and the frame member 35 can be prevented. Further, the shaping/cutting device 1702 cuts out the separator 30 from the separator sheet 30B. More specifically, the shaping/cutting device 1702 can cut out the separator 30 that is adhered to the frame member 35 by cutting the outside of the part of the separator sheet 30B that is adhered to the frame member 35 by the heat-sealing device 1701.

Herein, the post-processing device 1700 may execute the post-processing while moving along the conveying direction D in synchronization with the movement of the active material 22c and the separator 30 that is also conveyed along the conveying direction D. The manufacturing device 1000 may perform post-processing without stopping conveyance for post-processing by moving the heat-sealing device 1701 and the shaping/cutting device 1702 to fix their relative positions with respect to the separator 30. Due to this, the manufacturing device 1000 can further improve the manufacturing efficiency of the electrode 20.

Furthermore, when conveyance is stopped for post-processing, the stopping time needs to be short from the viewpoint of manufacturing efficiency. Then, it is necessary to execute post-processing within the limited downtime. On the other hand, when the heat-sealing device 1701 and the shaping/cutting device 1702 are moved and post-processing is executed without stopping the conveyance, such a time limit does not occur. Therefore, the manufacturing device 1000 can take sufficient time to perform various post-processing and further improve the quality of the electrode 20.

Herein, as shown in FIG. 3, after the separator 30 is cut out by the shaping/cutting device 1702, a surplus portion of the separator sheet 30B remains in the shape of a ladder. As shown in FIG. 3, the separator collecting device 1600 can wind up and collect the ladder-shaped surplus portion. In other words, the manufacturing device 1000 cuts out the separator 30 so as to leave both ends of the separator sheet 30B, so that the surplus portion is continuous and can be easily recovered.

### Second Embodiment

As described above, the separator 30 in the single cell 10 holds, for example, an electrolytic solution as an electrolyte. Such an electrolytic solution is poured into the separator 30 after each step shown in FIGS. 2 and 3, and so on.

In the second embodiment, a case, in which the step of pouring electrolytic solution into the separator 30 is reduced, will be described and the manufacturing efficiency of the electrode 20 is further improved. The manufacturing device 1000 according to the second embodiment has the same configuration as the manufacturing device 1000 described in the first embodiment. Hereinafter, the configurations explained in the first embodiment will be given the same reference numerals as in FIGS. 1 to 3 and the explanation will be omitted.

In the second embodiment, the active material 22c described above contains an electrolyte. The roller 1500 causes the electrolytic solution contained in the active material 22c to soak into the separator 30 from the active material 22c by sandwiching and compressing the current collector 21B, the active material 22c, and the separator 30.

For example, the active material 22c holds an electrolytic solution within a polymer. Specifically, each particle of the active material 22c can be provided with a resin layer. Herein, the active material 22c may be a coated active material in which at least a part of the surface is coated with a coating material containing a polymer compound. In this case, the resin layer can hold the electrolytic solution.

Alternatively, the active material 22c and the electrolytic solution may be simply mixed without having a resin layer on each particle of the active material 22c. In other words, the active material supply device 1300 may supply a slurry, in which the active material 22c and the electrolyte are mixed, to the strip-shaped current collector 21B.

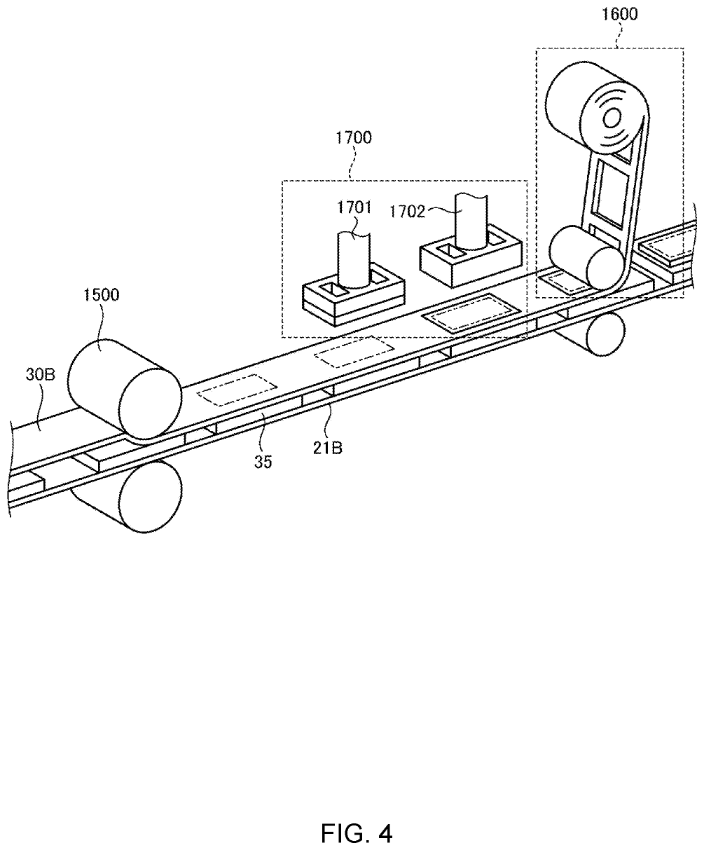

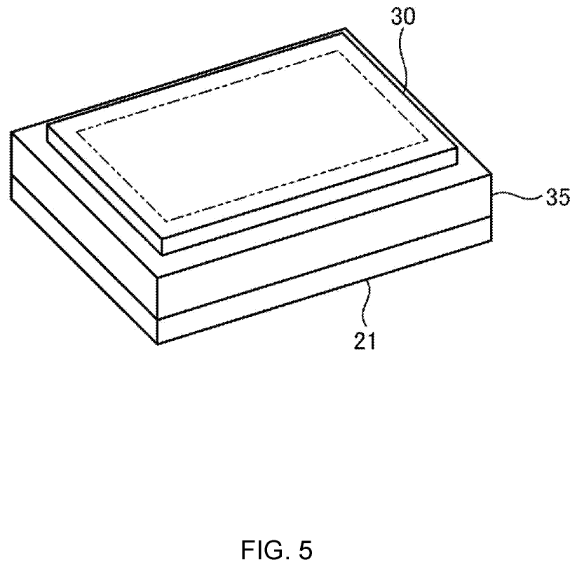

The roller 1500 sandwiches and compresses the active material 22c, which contains the electrolytic solution, and the separator 30. As a result, the electrolytic solution soaks into the region of the separator 30 shown by the broken line in FIGS. 4 and 5. The manufacturing device 1000 according to the second embodiment can reduce the step of pouring electrolytic solution.

Note that, as shown in FIG. 4, the post-processing by the post-processing device 1700 and the collection of the surplus portion by the separator collecting device 1600 can be performed in the same manner as in the first embodiment. Here, it is preferable that the heat-sealing device 1701 heat seals a region of the separator 30 outside the region where the electrolytic solution has been soaked. In other words, the electrolytic solution may be flammable, and unnecessary risks can be avoided by excluding the region where the electrolytic solution has been soaked from the region targeted for heat sealing.

Herein, after the above-mentioned step, the electrode 20 is manufactured by appropriately cutting out the current collector 21 from the strip-shaped current collector 21B. A single cell 10 is manufactured by stacking a pair of electrodes 20 (that is a cathode 20a and an anode 20b) while the pair of electrodes 30 faces each other via a separator 30, which is interposed therebetween. For example, a member in which one electrode 20 out of the cathode 20a or the anode 20b and the separator 30 have been stacked, is manufactured through the various steps shown in FIG. 2. The single cell 10 can be manufactured by overlapping the other electrode 20 onto the member. Note that the method for manufacturing the other electrode 20 is not particularly limited. Further, a battery is manufactured by stacking a plurality of single cells 10 along the thickness direction and sealing the plurality of single cells 10 with an exterior member.

As described above, the manufacturing device 1000 of the embodiment comprises: a separator supply device 1400 that supplies a separator 30 to an active material 22c, wherein the active material 22c has been stacked on a strip-shaped current collector 21B, wherein the active material 22C is conveyed along a conveying direction D in a chamber 1100 whose interior is decompressed below atmospheric pressure; and a roller 1500 that compresses the active material 22c, which has been supplied on the current collector 21B, via the separator 30. With this configuration, the manufacturing device 1000 can improve the manufacturing efficiency and quality of the electrode 20.

Furthermore, the manufacturing device 1000 supplies the active material 22c onto the current collector 21B and compresses the active material 22c in a chamber 1100 whose interior is decompressed below atmospheric pressure. Due to this, the manufacturing device 1000 can make it difficult for air to be included in the active material 22c. Therefore, the manufacturing device 1000 can avoid a situation in which unevenness is formed on the surface of the active material layer 22 due to the expansion of air during various steps after compressing the active material 22c or during the use of the battery.

Although the first embodiment and the second embodiment have been described above in detail with reference to the figures, the specific configuration is not limited to these embodiments. This invention also includes modifications, combinations, deletions, etc. of the configuration without departing from the gist of the present invention. Furthermore, it is needless to say that the configurations shown in each embodiment can be used in appropriate combinations. For example, in the first embodiment and the second embodiment, the frame member supply device 1200 may be arranged in the downstream side D1 from the active material supply device 1300. In other words, after the active material 22c is supplied onto the current collector 21B, the frame member 35 may be supplied onto the current collector 21B. In this case, the frame member supply device 1200 supplies the frame member 35 onto the current collector 21B so that the active material 22c, which has been supplied onto the current collector 21B, enters the internal space of the frame member 35. With this configuration, the frame member 35 can be supplied onto the current collector 21B after the active material 22c is supplied onto the current collector 21B. Alternatively, a mask may be formed on the current collector 21B before the frame member 35 is supplied to the current collector 21B, and the frame member 35 may be supplied at the position of the mask at an arbitrary timing thereafter. Alternatively, the manufacturing device 1000 may not comprise the frame member supply device 1200.

### Third Embodiment

As explained in the first embodiment and the second embodiment, in order to suppress the adhesion of the active material to the roller surface during roll pressing, it is conceivable that the press is conducted while the separator is sandwiched between the roller and the active material. However, in this case, there is a concern that the separator may be undulated (wrinkled) when pressing.

In order to avoid causing wrinkles on the separator, it is possible to stack a reinforcing material on the separator as described in Patent Document 3. However, such reinforcing material does not contribute to battery performance and also causes the battery to become thicker. Moreover, if such a reinforcing material is to be collected later, the number of steps required to manufacture the battery will increase, which is not desirable from the viewpoint of manufacturing efficiency.

In the third embodiment, a battery electrode manufacturing device that can suppress the adhesion of the active material to the roller and wrinkles of the separator while improving the manufacturing efficiency of battery electrodes will be described.

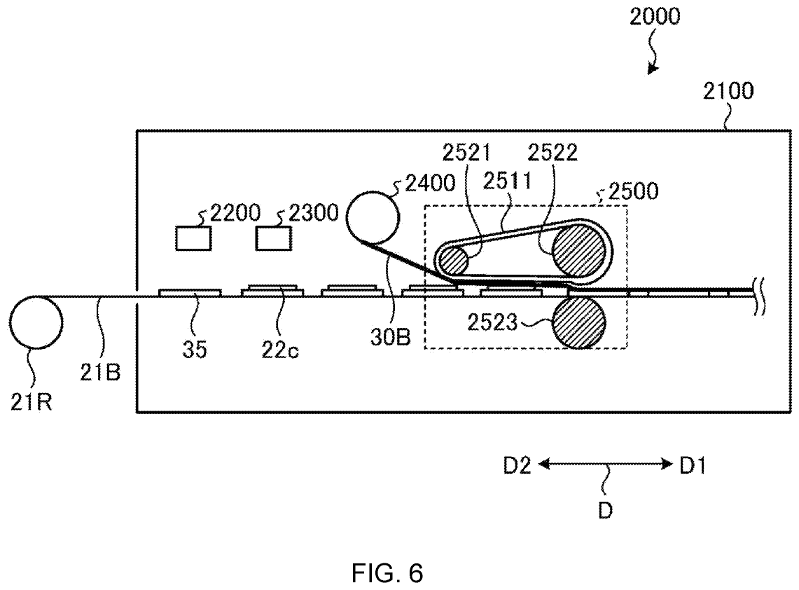

A manufacturing device and a battery electrode manufacturing method according to the third embodiment will be described by referring to FIG. 6. FIG. 6 is a schematic diagram showing the manufacturing device 2000. For example, the manufacturing device 2000 comprises a chamber 2100, a frame member supply device 2200, an active material supply device 2300, a separator supply device 2400, and a compression device 2500. The separator supply device is an example of a separator supply unit and an example of a film supply unit. The compression device 2500 is an example of a compression unit.

The chamber 2100 functions as a room in which the inside space can be maintained at a pressure lower than the atmospheric pressure. The inside of the chamber 2100 is decompressed below atmospheric pressure by a decompress pump, which is not shown in the figure. The standard atmospheric pressure is approximately 1013 hPa (approximately 10⁵ Pa).

For example, a current collector roll 21R is arranged outside of the chamber 2100 and a strip-shaped current collector 21B pulled out from the current collector roll 21R, is conveyed into the chamber 2100 through a slit. Note that the current collector 21B is the current collector 21 before being cut into a predetermined shape. The current collector 21B is conveyed along the conveying direction D. For example, the current collector 21B is conveyed at a predetermined speed by a conveying device such as a belt conveyor. In the following description, the direction in which the current collector 21B is conveyed is referred to as the downstream side D1, and the opposite direction is referred to as the upstream side D2. Note that the external space of the chamber 2100 in which the current collector roll 21R is arranged may be at normal pressure or may be reduced in pressure by a chamber, which is different from the chamber 2100.

The frame member supply device 2200 supplies the frame member 35 to the current collector 21B being conveyed. Note that although FIG. 6 shows a case where the frame member supply device 2200 is arranged inside the chamber 2100, the frame member supply device 2200 may be arranged outside the chamber 2100. For example, the frame member supply device 2200 has a robot arm and places the frame member 35, which has been manufactured in advance, at a predetermined position on the current collector 21B being conveyed. Note that after the frame member 35 is placed on the current collector 21B, the current collector 21B and the frame member 35 may be compressed using a roll press, which is different from the compression device 2500, so as to sandwich the current collector 21B and the frame member 35.

Note that the method for manufacturing the frame member 35 is not particularly limited. For example, the frame member 35 can be formed into a predetermined shape by cutting a sheet or block made of a predetermined material such as a polymeric material. For example, the frame member 35 is obtained by punching out a material sheet made of a predetermined material.

Further, for example, the frame member 35 can be formed into a predetermined shape by a method using a frame mold such as injection molding. For example, a mold having an internal space of a predetermined shape is prepared in advance, and the frame member 35 can be formed into the predetermined shape by performing injection molding on the mold.

Further, for example, the frame member 35 can be formed into a predetermined shape by discharging or applying a predetermined material onto the substrate. For example, the frame member 35 can be formed into a predetermined shape by a dispenser. The frame member 35 can be formed by discharging a predetermined amount of a predetermined material from a nozzle onto a substrate under the control of a dispenser. For example, the frame member 35 can also be formed by applying a predetermined material onto a substrate in a predetermined shape using a coater such as a screen-printer.

More specifically, the frame member 35 can be formed by discharging or applying a predetermined material onto a substrate in a predetermined shape using a dispenser, coater, etc., and peeling it off from the substrate after drying. Alternatively, the frame member 35 can be formed by discharging or applying a predetermined material such as a two-component curing resin or a UV curing resin onto a substrate using a dispenser or a coater so as to have a predetermined shape and peeling it off from the substrate after curing.

In addition, the frame member 35 can be formed into a predetermined shape using various methods. For example, the frame member 35 may be formed into a predetermined shape by assembling sheets or blocks made of a predetermined material so as to have a predetermined shape. Further, for example, the frame member 35 may be formed into a predetermined shape by arranging a sheet made of a predetermined material in the longitudinal direction of the substrate and discharging or applying the material in the vertical direction. Alternatively, the frame member 35 can also be manufactured using any type of 3D printer.

Furthermore, although the frame member 35, which has been manufactured in advance, is placed on the current collector 21B in FIG. 6, the embodiment is not limited thereto. For example, the frame member 35 may be manufactured on the current collector 21B. For example, in a case when the current collector 21B is used as a substrate, the frame member 35 can be formed on the current collector 21B by discharging or applying a predetermined material in a predetermined shape onto the current collector 21B using a dispenser, coater, etc.

As shown in FIG. 6, the active material supply device 2300 supplies the active material 22c onto the current collector 21B, which is conveyed in the chamber 2100. The active material 22c refers to a plurality of granulated electrode particles containing an electrode active material and a conductive assistant. For example, the active material supply device 2300 comprises a hopper that holds an active material therein, and a shutter that opens and closes an opening of the hopper. The active material supply device 2300 can supply a desired amount of active material 22c to a desired position along the conveying direction D on the current collector 21B, which is conveyed, by opening and closing the shutter.

After each step shown in FIG. 6, the current collector layer 21 shown in FIG. 1 is formed by dividing the strip-shaped current collector 21B into predetermined units. The active material supply device 2300 manufactures a member sheet in which a plurality of members including the current collector layer 21 and the active material 22c are connected by supplying the active material 22c onto the current collector layer 21 (that is, the current collector 21B) before the current collector layer 21 is divided.

The separator supply device 2400 supplies the separator 30 to the member sheet. Specifically, the separator supply device 2400 supplies the separator 30 by overlapping the strip-shaped separator sheets 30B to the active material 22c, which has been stacked on the current collector 21B, while conveying the strip-shaped separator sheets 30B along the conveying direction D. For example, the separator supply device 2400 comprises a separator roll 30R and a drive mechanism that draws out the separator sheet 30B from the separator roll 30R. The separator supply device 2400 overlaps the member sheet, which is conveyed at a predetermined speed along the conveying direction D, with the separator sheet 30B while conveying the separator sheet 30B at the same predetermined speed. More specifically, separator supply device 2400 comprises a roller, which is positioned above the member sheet, being conveyed as a drive mechanism. The separator supply device 2400 can supply the separator 30 to the active material 22c by pressing the separator sheet 30B against the member sheet using the roller while conveying the separator sheet 30B at a predetermined speed. Note that some or all of the rollers included in the compression device 2500, which will be described later, may function as a drive mechanism for conveying the separator sheet 30B at a predetermined speed.

The compression device 2500 forms the active material layer 22 shown in FIG. 1 by compressing the active material 22c, which has been supplied onto the current collector 21B. Specifically, the compression device 2500 comprises a roller 2522 and a roller 2523. The compression device 2500 compresses the member sheet and the separator 30 by sandwiching them between the rollers 2522 and 2523, while sandwiching the active material 22c between the current collector layer 21 and the separator 30. With this configuration, among the single cell 10 shown in FIG. 1, a member consisting of one side electrode 20 and the separator 30 is manufactured. Note that the roller 2522 is an example of a first roller. Moreover, the roller 2523 is an example of a second roller.

As shown in FIG. 6, the manufacturing device 2000 can continuously manufacture the members of the single cell 10 including the current collector layer 21, the active material layer 22, the separator 30, and the frame member 35. In other words, the manufacturing device 2000 can continuously manufacture the electrodes 20 stacked with the separators 30. Further, as shown in FIG. 6, in terms of the manufacturing device 2000, the compression of the active material 22c is conducted while the separator 30 is sandwiched between the roller 2522 and the active material 22c. Therefore, the manufacturing device 2000 can prevent the active material 22c from adhering to the roller 2522. As a result, the manufacturing device 2000 can prevent the surface of the active material layer 22 formed by compression of the active material 22c from becoming uneven. Also, the manufacturing device 100 can prevent the amount of the active material 22c contained in the electrode 20 from becoming unstable. In conclusion, the manufacturing device 2000 can improve the manufacturing efficiency and quality of the electrode 20.

Further, as shown in FIG. 6, the compression device 2500 comprises a roller 2521 and a ring member 2511. The ring member 2511 is a deformable member made of rubber or the like, and is driven by the roller 2521 and the roller 2522. The ring member 2511 rotates around the roller 2521 and the roller 2522 using the rotation of the roller 2521 and the roller 2522, as power. In other words, in FIG. 6, the ring member 2511, the roller 2521, and the roller 2522 form a crawler. The roller 2521 is an example of a third roller located upstream D2 along the conveying direction D from the first roller (roller 2522).

As shown in FIG. 6, the separator 30 contacts the ring member 2511 at the position of the roller 2521. The roller 2521 presses the ring member 2511 into contact with the separator sheet 30B supplied from the separator supply device 2400. Thereafter, the separator 30 is conveyed to the position of the roller 2522 and is compressed by being sandwiched between the roller 2522 and the roller 2523 together with the ring member 2511 and the member sheet.

As mentioned above, the separator 30 is held by the ring member 2511 between the section from the roller 2521 to the roller 2522. The separator 30 (separator sheet 30B) is generally a thin sheet and easily gets wrinkled. However, the generation of wrinkles is suppressed by holding the separator 30 using the ring member 2511 before pressing.

Additionally, the separator 30 generally has a smooth surface. For example, if the separator 30 is directly pressed by the roller 2522, slippage may occur between the roller 2522 and the separator 30, which will result in causing wrinkles on the separator 30. Herein, by having the ring member 2511 made from a flexible material such as rubber, the slippage of the separator 30 with respect to the roller 2522 when roll pressing is suppressed, and the generation of wrinkles is thereby suppressed.

Furthermore, the ring member 2511 is used for reinforcing the separator 30 during roll pressing, but after the roll pressing is completed, the ring member 2511 is separated from the separator 30 and is not included in the product (single cell 10, assembled battery made of these, etc.). Therefore, the manufacturing device 2000 can improve the manufacturing efficiency and quality of battery electrodes while suppressing the adhesion of the active material to the roller 2522 and wrinkles of the separator 30.

It is noted that members such as the ring member 2511 deteriorate over time and therefore need to be replaced periodically. In this case, it is not necessary to replace the rollers 2521 and the roller 2522, and only the ring member 2511 can be replaced with a new one. In other words, in order to prevent wrinkles on the separator 30, if the roller 2522 is made from a flexible material such as rubber, the roller 2522 itself must be replaced periodically. On the other hand, as shown in FIG. 6, a plurality of rotating rollers including the roller 2522 and the ring member 2511 constitute a crawler. With this configuration, it is possible to replace only the ring member 2511 and maintenance costs for the manufacturing device 2000, can be reduced.

In addition, in FIG. 6, three rollers (roller 2521, roller 2522, and roller 2523) are illustrated as a plurality of rotating rollers included in the compression device 2500. However, the embodiment is not limited to this, and various modifications can be made to the arrangement and number of the plurality of rotating rollers included in the compression device 2500.

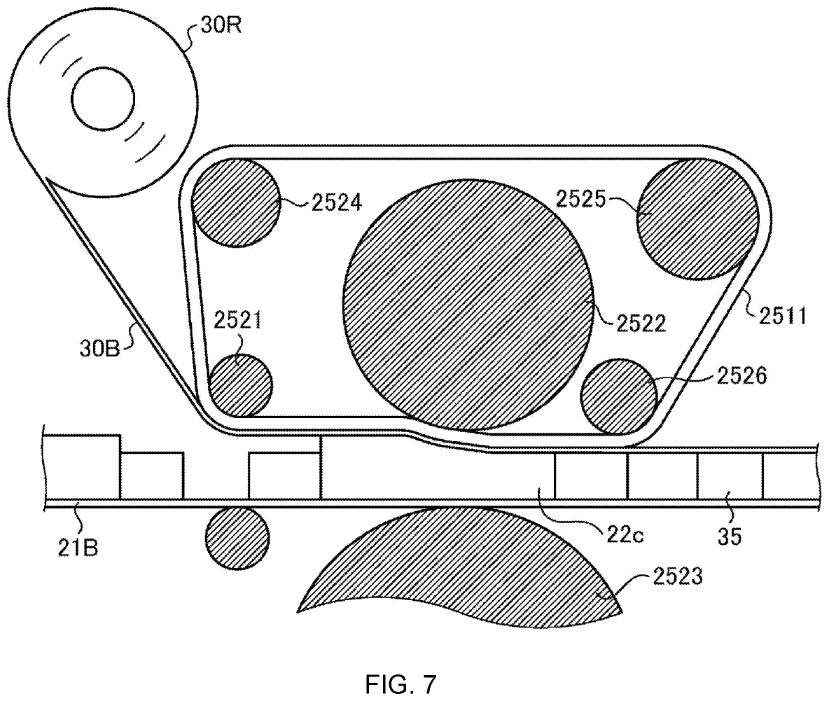

For example, as shown in FIG. 7, the compression device 2500 may further comprise a roller 2524, a roller 2525, and a roller 2526 as a plurality of rotating rollers. In the case shown in FIG. 7, the ring member 2511 is driven by the rollers 2521, the roller 2522, the roller 2524, the roller 2525, and the roller 2526. Further, in a state where the ring member 2511 is located between the roller 2522 and the separator 30, the rollers 2522 and 2523 sandwich and compress the separator 30 and the member sheet, which has the current collector layer 21 and the active material 22c, wherein the active material 22c has been stacked onto the current collector layer 21.

Alternatively, the ring member 2511 may be driven by a single rotating roller. For example, the roller 2521 may be omitted from FIG. 6 and the ring member 2511 may be attached onto the circumference of the roller 2522. In this case, the separator 30 cannot be held by the ring member 2511 before pressing (between the section from the roller 2521 to the roller 2522). However, since slippage between the roller 2522 and the separator 30 is suppressed, it is possible to suppress the generation of wrinkles.

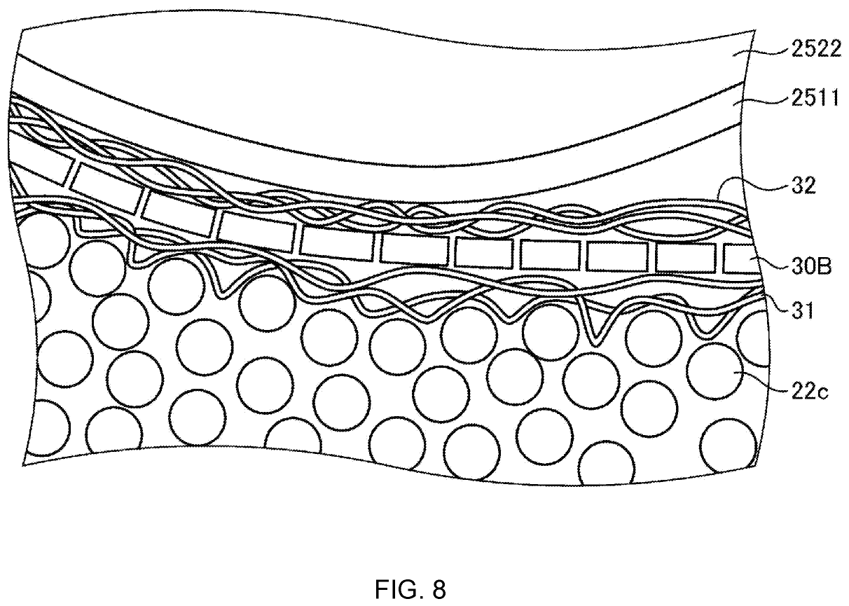

Further, in order to further suppress the occurrence of wrinkles on the separator 30, a reinforcing sheet may be provided to the separator 30. FIG. 8 shows an example of the reinforcing sheet. FIG. 8 shows a case where a first reinforcing sheet 31 is provided on the lower surface of the separator sheet 30B and a second reinforcing sheet 32 is provided on the upper surface of the separator sheet 30B. Note that although FIG. 8 shows a case where the ring member 2511 is driven by a single rotating roller, the ring member 2511 may be driven by a plurality of rotating rollers as shown in FIGS. 6 and 7.

The first reinforcing sheet 31 and the second reinforcing sheet 32 are, for example, nonwoven fabrics. During roll pressing, the first reinforcing sheet 31 is located between the separator 30 and the active material 22c. Further, the second reinforcing sheet 32 is located between the separator 30 and the ring member 2511. The compression device 2500 sandwiches and compresses the member sheet and the separator 30 in a state where the active material 22c in the member sheet and the first reinforcing sheet 31 are in contact with each other, and the ring member 2511 and the second reinforcing sheet 32 are in contact with each other.

By providing the first reinforcing sheet 31 and the second reinforcing sheet 32, the separator 30 becomes strong and wrinkles are less likely to occur. Moreover, since the first reinforcing sheet 31 is a non-woven fabric, it is expected that slippage of the separator 30 against the active material 22c can be avoided. The surface of the nonwoven fabric is rough, and during roll pressing, it bites into the active material 22c and stops the slippage. Thereby, the occurrence of wrinkles on the separator 30 can be further suppressed.

Although the first reinforcing sheet 31 and the second reinforcing sheet 32 have been described as nonwoven fabrics, the embodiment is not limited thereto. For example, the first reinforcing sheet 31 and the second reinforcing sheet 32 may be woven cloth. In addition, any material can be selected as long as it can retain electrolytic solution and ensure lithium-ion conductivity.

Furthermore, although a case where the reinforcing sheets are provided on both sides of the separator 30 has been described, one of the reinforcing sheets may be omitted. For example, the separator 30 may be provided with only the first reinforcing sheet 31. In this case, the compression device 2500 sandwiches and compresses the member sheet and the separator 30 in a state where the active material 22c in the member sheet and the first reinforcing sheet 31 are in contact with each other, and the ring member 2511 and the separator 30 are in contact with each other.

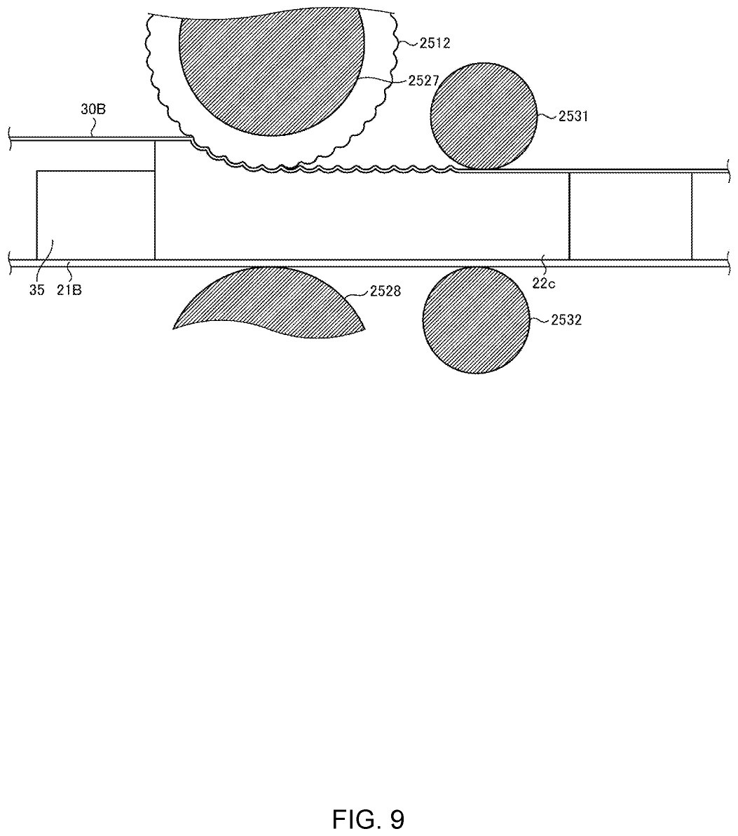

In addition, in order to further suppress the occurrence of wrinkles on the separator 30, a ring member 2512 having irregularities may be used instead of the ring member 2511 shown in FIGS. 6 to 8. An example of the ring member 2512 is shown in FIG. 9. As shown in FIG. 9, in terms of the ring member 2512, irregularities are formed on the side that contacts the separator 30. Note that although FIG. 9 shows a case in which the ring member 2512 is driven by a single rotating roller (roller 2527), the ring member 2512 may be driven by a plurality of rotating rollers, similar to the ring member 2511 in FIGS. 6 and 7.

The rollers 2527 and 2528 shown in FIG. 9 sandwich and compress the separator 30 and the member sheet including the current collector layer 21 and the active material 22c, which has been stacked to the current collector layer 21, in a state where the ring member 2512 is located between the roller 2527 and the separator 30. Herein, since the ring member 2512 comprises irregularities, the surfaces of the separator 30 and the active material 22c have irregularities as shown in FIG. 9, and the separator 30 bites into the active material 22c.

As shown in FIG. 9, the manufacturing device 2000 further comprises a high-precision compression device 253. In the case shown in FIG. 9, the high-precision compression device 253 is composed of a pair of rollers, a roller 2531 and a roller 2532. The roller 2531 and the roller 2532 compress the member sheet and separator 30 again after being compressed by the compression device 2500, and flatten the separator 30. In the case shown in FIG. 9, the surfaces of the separator 30 and the active material 22c have irregularities due to compression by the compression device 2500 including the ring member 2512, which has irregularities. The roller 2531 and the roller 2532 flatten the irregularities formed on the surfaces of the separator 30 and the active material 22c by performing compression again.

It is thought that wrinkling occurs on the separator 30 when the active material 22c is compressed. For example, when the active material 22c is compressed by the roller 2527 and the roller 2528, the thickness of the active material 22c changes, and the position of the separator 30 disposed on the surface of the active material 22c, also changes. The wrinkles may occur on the separator 30 due to this change. However, in the case shown in FIG. 9, irregularities occur on the surfaces of the separator 30 and the active material 22c and the separator 30 bites into the active material 22c. This suppresses the generation of wrinkles on the separator 30 when the active material 22c is compressed by the roller 2527 and the roller 2528. Note that when the active material 22c is compressed by the roller 2531 and the roller 2532, the thickness of the active material 22c does not change, so it is considered that wrinkles do not normally occur on the separator 30.

Note that various modifications can be made to the shape of the irregularities formed on the ring member 2512. Specifically, it can be adopted as a shape of irregularities formed on the ring member 2512 as long as the pattern includes changes along the circumferential direction of the roller 2527 in the cross-section perpendicular to the rotation axis of the roller 2527 as shown in FIG. 9.

After the various compression steps described above, the separator 30 is cut out from the separator sheet 30B, the separator 30 is heat-sealed to the frame member 35, and the current collector layer 21 is cut out from the strip-shaped current collector 21B. And then, the electrode 20 has been manufactured. The single cell 10 is manufactured by stacking a pair of electrodes 20 (that is a cathode 20a and an anode 20b) while the pair of electrodes 20 faces each other via the separator 30, which is interposed therebetween. For example, a member in which one electrode 20 out of the cathode 20a or the anode 20b and the separator 30 have been stacked, is manufactured through the various steps shown in FIG. 6. The single cell 10 can be manufactured by overlapping another electrode 20 onto the member. Note that the method for manufacturing the other electrode 20 is not particularly limited. Further, a battery is manufactured by stacking a plurality of single cells 10 along the thickness direction and sealing the plurality of single cells 10 with an exterior member.

As described above, the manufacturing device 2000 of the third embodiment comprises: the separator supply device 2400 that supplies the separator 30 to the active material 22c, wherein the active material 22c has been stacked on the strip-shaped current collector 21B, wherein the active material 22c is conveyed along the conveying direction D in the chamber 2100 whose interior is decompressed below atmospheric pressure, by overlapping the strip-shaped separator sheet 30B to the active material 22c, which is conveyed, while conveying the strip-shaped separator sheet 30B along the conveying direction; and the compression device 2500 comprising a plurality of the rotating rollers and the ring member (the ring member 2511 or the ring member 2512), which are driven by the plurality of rotating rollers. And the compression device 2500 sandwiches and compresses the active material 22c via the separator 30 in a state where the ring member and the separator 30 are in contact with each other. In other words, at the compression part, the manufacturing device 2000 compresses the active material 22c via the separator 30 in a state where the ring member and the separator 30 are in contact with each other. With this configuration, the manufacturing device 2000 can suppress the adhesion of the active material to the roller and wrinkles of the separator while improving the manufacturing efficiency of battery electrodes.

Furthermore, the manufacturing device 2000 supplies the active material 22c onto the current collector 21B and compresses the active material 22c in a chamber 2100 whose interior is decompressed below atmospheric pressure. Due to this, the manufacturing device 1000 can make it difficult for air to be included in the active material 22c. Therefore, the manufacturing device 2000 can avoid a situation in which unevenness is formed on the surface of the active material layer 22 due to expansion of air during various steps after compressing the active material 22c or during usage of the battery.

Although the third embodiment has been described above in detail with reference to the figures, the specific configuration is not limited to these embodiments. This invention also includes modifications, combinations, deletions, etc. of the configuration without departing from the gist of the present invention. Furthermore, it is needless to say that the configurations shown in each embodiment can be used in appropriate combinations. For example, in the third embodiment, the frame member supply device 2200 may be arranged in the downstream side D1 from the active material supply device 2300. In other words, after the active material 22c is supplied onto the current collector 21B, the frame member 35 may be supplied onto the current collector 21B. In this case, the frame member supply device 2200 supplies the frame member 35 onto the current collector 21B so that the active material 22c, which has been supplied onto the current collector 21B, enters the internal space of the frame member 35. With this configuration, the frame member 35 can be supplied onto the current collector 21B after the active material 22c is supplied onto the current collector 21B. Alternatively, a mask may be formed on the current collector 21B before the frame member 35 is supplied to the current collector 21B, and the frame member 35 may be supplied at the position of the mask at an arbitrary timing thereafter. Alternatively, the manufacturing device 2000 may not comprise the frame member supply device 2200.

### Fourth Embodiment

In the first to third embodiments described above, as an example of a film supply unit that supplies a film to the active material, the separator supply device 1400 and the separator supply device 2400 that supply the separator 30 have been described. In the fourth embodiment, as an example of a film supply unit that supplies a film to the active material, a release film supply device 400 that supplies a release film 40B will be described.

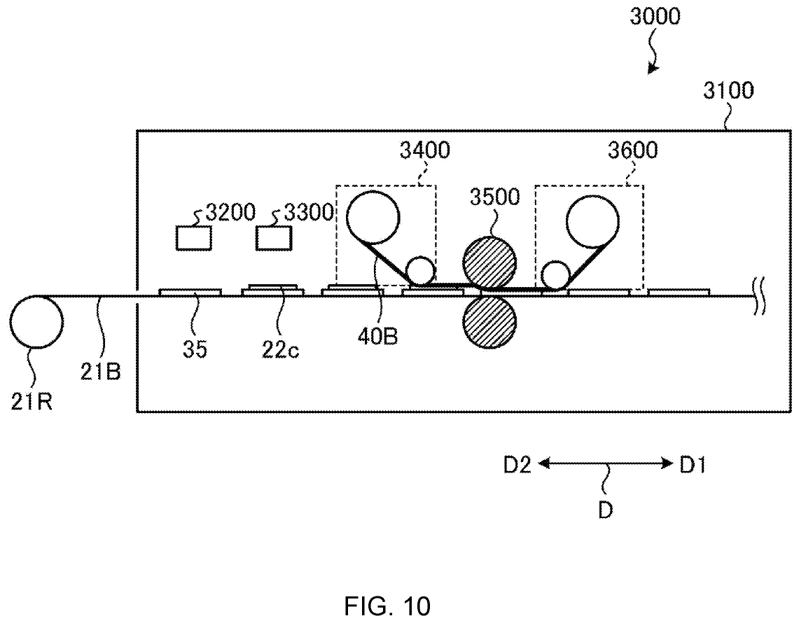

A manufacturing device and a battery electrode manufacturing method according to the fourth embodiment will be described by referring to FIG. 10. FIG. 10 is a schematic diagram showing the manufacturing device 3000. For example, the manufacturing device 3000 comprises a chamber 3100, a frame supply device 3200, an active material supply device 3300, a release film supply device 3400, a roller 3500, and a release film collecting device 3600. The release film supply device is an example of a release film supply unit and an example of a film supply unit. The roller 3500 is an example of a compression unit. Hereinafter, the case where a base film is a strip-shaped current collector 21B will be described as an example.

The chamber 3100 functions as a room in which the inside space can be maintained at a pressure lower than the atmospheric pressure. The inside of the chamber 3100 is decompressed below atmospheric pressure by a decompress pump, which is not shown in the figure. The standard atmospheric pressure is approximately 1013 hPa (approximately 10⁵ Pa).

For example, a current collector roll 21R is arranged outside of the chamber 3100, and a strip-shaped current collector 21B pulled out from the current collector roll 21R is conveyed into the chamber 3100 through a slit. Note that the current collector 21B is the current collector 21 before being cut into a predetermined shape. The current collector 21B is conveyed along the conveying direction D. For example, the current collector 21B is conveyed at a predetermined speed by a conveying device such as a belt conveyor. In the following description, the direction in which the current collector 21B is conveyed is referred to as the downstream side D1, and the opposite direction is referred to as the upstream side D2. Note that the external space of the chamber 3100 in which the current collector roll 21R is arranged may be at normal pressure or may be reduced in pressure by a chamber, which is different from the chamber 3100.

The frame member supply device 3200 supplies the frame member 35 to the current collector 21B being conveyed. Note that although FIG. 10 shows a case where the frame member supply device 3200 is arranged inside the chamber 3100, the frame member supply device 3200 may be arranged outside the chamber 3100. For example, the frame member supply device 3200 has a robot arm, and places the frame member 35, which has been manufactured in advance, at a predetermined position on the current collector 21B being conveyed. Note that after the frame member 35 is placed on the current collector 21B, the current collector 21B and the frame member 35 may be compressed using a roll press, which is different from the compression device 3500, so as to sandwich the current collector 21B and the frame member 35.

Note that the method for manufacturing the frame member 35 is not particularly limited. For example, the frame member 35 can be formed into a predetermined shape by cutting a sheet or block made of a predetermined material such as a polymeric material. For example, the frame member 35 is obtained by punching out a material sheet made of a predetermined material.

Further, for example, the frame member 35 can be formed into a predetermined shape by a method using a frame mold such as injection molding. For example, a mold having an internal space of a predetermined shape is prepared in advance, and the frame member 35 can be formed into the predetermined shape by performing injection molding on the mold.

Further, for example, the frame member 35 can be formed into a predetermined shape by discharging or applying a predetermined material onto the substrate. For example, the frame member 35 can be formed into a predetermined shape by a dispenser. The frame member 35 can be formed by discharging a predetermined amount of a predetermined material from a nozzle onto a substrate under the control of a dispenser. For example, the frame member 35 can also be formed by applying a predetermined material onto a substrate in a predetermined shape using a coater such as a screen printer.

More specifically, the frame member 35 can be formed by discharging or applying a predetermined material onto a substrate in a predetermined shape using a dispenser, coater, etc., and peeling it off from the substrate after drying. Alternatively, the frame member 35 can be formed by discharging or applying a predetermined material such as a two-component curing resin or a UV curing resin onto a substrate using a dispenser or a coater so as to have a predetermined shape, and peeling it off from the substrate after curing.

In addition, the frame member 35 can be formed into a predetermined shape using various methods. For example, the frame member 35 may be formed into a predetermined shape by assembling sheets or blocks made of a predetermined material so as to have a predetermined shape. Further, for example, the frame member 35 may be formed into a predetermined shape by arranging a sheet made of a predetermined material in the longitudinal direction of the substrate and discharging or applying the material in the vertical direction. Alternatively, the frame member 35 can also be manufactured using any type of 3D printer.

Furthermore, although the frame member 35, which has been manufactured in advance, is placed on the current collector 21B in FIG. 10, the embodiment is not limited thereto. For example, the frame member 35 may be manufactured on the current collector 21B. For example, in a case when the current collector 21B is used as a substrate, the frame member 35 can be formed on the current collector 21B by discharging or applying a predetermined material in a predetermined shape onto the current collector 21B using a dispenser, coater, etc.

As shown in FIG. 10, the active material supply device 3300 supplies the active material 22c onto the current collector 21B, which is conveyed in the chamber 3100. The active material 22c refers to a plurality of granulated electrode particles containing an electrode active material and a conductive assistant. For example, the active material supply device 3300 comprises a hopper that holds an active material therein, and a shutter that opens and closes an opening of the hopper. The active material supply device 3300 can supply a desired amount of active material 22c to a desired position along the conveying direction D on the current collector 21B, which is conveyed, by opening and closing the shutter.

After each step shown in FIG. 10, the current collector layer 21 shown in FIG. 1 is formed by dividing the strip-shaped current collector 21B into predetermined units. The active material supply device 3300 manufactures a member sheet in which a plurality of members including the current collector layer 21 and the active material 22c are connected by supplying the active material 22c onto the current collector layer 21 (that is, the current collector 21B) before the current collector layer 21 is divided.

The release film supply device 3400 supplies the release film 40B to the member sheet. Specifically, the release film supply device 3400 supplies the release film 40B to the active material 22c, which has been stacked on the current collector 21B. Although the material of the release film 40B is not particularly limited, PET (Polyethylene terephthalate) can be used as an example. Further, a release agent may be applied to the surface of the release film 40B. For example, the release film supply device 3400 comprises a release film roll 40R in which the strip-shaped release film 40B is wound into a roll, and a drive mechanism that pulls out the release film from the release film roll 40R. The release film supply device 3400 overlaps the release film 40B on the member sheet that is conveyed at a predetermined speed along the conveying direction D while conveying the release film 40B at the same predetermined speed. More specifically, the release film supply device 3400 comprises a roller located above the member sheet being conveyed as a drive mechanism. The release film supply device 3400 can supply the release film 40B to the member sheet by pressing the release film 40B against the member sheet while conveying the release film 40B at a predetermined speed using the roller.

The roller 3500 forms the active material layer 22 shown in FIG. 1 by compressing the active material 22c, which has been supplied onto the current collector 21B. Specifically, the rollers 3500 sandwich and compress the member sheet and the release film 40B while the active material 22c is sandwiched between the current collector layer 21 and the release film 40B. In other words, the roller 1500 compresses the active material 22c via the release film 40B. As a result, among the single cell 10 shown in FIG. 1, one side of the electrode 20 is manufactured.

The release film collecting device 3600 peels and collects the release film 40B, which has been compressed by the roller 3500, from the active material 22c. For example, the release film collecting device 3600 can wind up the release film 40B after it has been compressed by the roller 3500, and manage it in the form of a roll that can be easily disposed of or reused.

As shown in FIG. 10, the manufacturing device 3000 can continuously manufacture one side of the electrode 20 of the single cell 10. Also, as shown in FIG. 10, in terms of the manufacturing device 3000, the compress of the active material 22c is conducted while the release film 40B is sandwiched between the roller 3500 and the active material 22c. Therefore, the manufacturing device 3000 can prevent the active material 22c from adhering to the roller 3500. As a result, the manufacturing device 3000 can prevent the surface of the active material layer 22 formed by compression of the active material 22c from becoming uneven. Also, the manufacturing device 100 can prevent the amount of the active material 22c contained in the electrode 20 from becoming unstable. In conclusion, the manufacturing device 3000 can improve the manufacturing efficiency and quality of the electrode 20.

After the above-mentioned each step, the electrode 20 is manufactured by appropriately cutting out the current collector 21 from the strip-shaped current collector 21B. A single cell 10 is manufactured by stacking a pair of electrodes 20 (that is, a cathode 20a and an anode 20b) while the pair of electrodes 30 faces each other via a separator 30, which is interposed therebetween. For example, one electrode 20 out of the cathode 20a or the anode 20b is manufactured through the various steps shown in FIG. 10. Hereinafter, the electrode 20 manufactured by the various steps shown in FIG. 10 will be referred to as a first electrode, and the other electrode 20 will be referred to as a second electrode. The current collector layer 21 formed by cutting out the current collector 21B shown in FIG. 10 and the active material layer 22 formed by compressing the active material 22c with the roller 3500 are in accordance with the first electrode side.

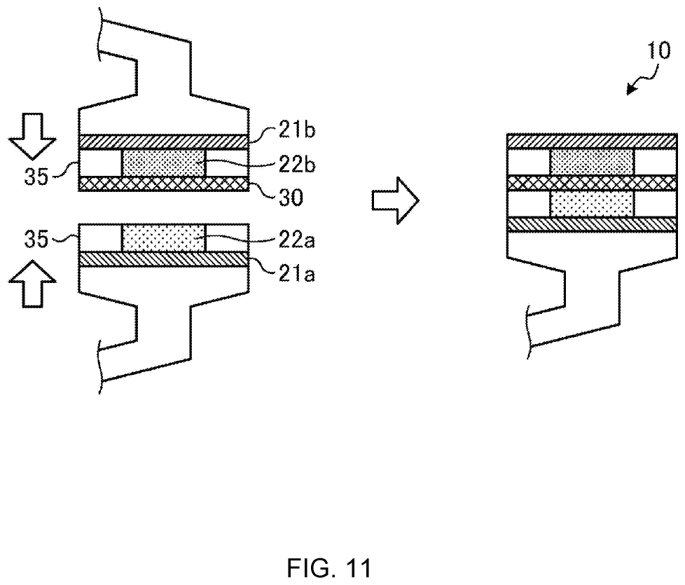

The manufacturing device 3000 may further comprise a combining device 3700 that manufactures the single cell 10 by combining the separator 30 and the second electrode with respect to the first electrode. FIG. 11 shows an example of the combining device 3700.

For example, the combining device 3700 holds another pole member sheet including the current collector layer 21b, the active material layer 22b, and the separator 30. The current collector layer 21b is an example of the another pole current collector layer corresponding to the second electrode side. In addition, the active material layer 22b is an example of another pole active material layer that has been stacked on the current collector layer 21b and corresponds to the second electrode side. Furthermore, the combining device 3700 holds a member sheet including the current collector layer 21a and the active material layer 22a. The member sheet is a member sheet that has been compressed by the roller 3500 shown in FIG. 10. Then, as shown in FIG. 11, the combining device 3700 combines the another pole member sheet with the active material 22c and the current collector 21B after being compressed by the roller 3500 so that the separator 30 and the active material layer 22a are in contact with each other. With this, the combining device 3700 can manufacture the single cell 10.

The method for manufacturing the another pole member sheet described above is not particularly limited. Further, the another pole member sheet may be combined one by one for each single cell 10. The another pole member sheet may be combined continuously, for example, before cutting out the current collector layer 21 from the strip-shaped current collector 21B. The battery 10 is manufactured by stacking a plurality of single cells 20 along the thickness direction and by sealing the plurality of single cells 10 with the exterior body.

As described above, the manufacturing device 3000 of the fourth embodiment comprises: a release film supply device 400 that supplies a release film 40B to the active material 22c, which is conveyed along the conveying direction D whose interior is decompressed below atmospheric pressure, wherein the active material 22c has been stacked on a strip-shaped current collector 21B; and a roller 3500 that compresses the active material 22c, which has been supplied on the current collector 21B, via the release film 40B. With this configuration, the manufacturing device 3000 can improve the manufacturing efficiency and quality of the electrode 20.

Furthermore, the manufacturing device 3000 supplies the active material 22c onto the current collector 21B and compresses the active material 22c in a chamber 3100 whose interior is decompressed below atmospheric pressure. Due to this, the manufacturing device 3000 can make it difficult for air to be included in the active material 22c. Therefore, the manufacturing device 3000 can avoid a situation in which unevenness is formed on the surface of the active material layer 22 due to expansion of air during various steps after compressing the active material 22c or during use of the battery.

In addition, although the embodiment mentioned above was explained that the base film is a current collector, the embodiment is not limited to this. For example, instead of the strip-shaped current collector 21B shown in FIG. 10, a strip-shaped separator sheet 30B may be used as a base film. In this case, the separator 30 manufactured by cutting out from the separator sheet 30B is an example of a base film layer. Further, the manufacturing device 3000 can continuously manufacture a member consisting of the separator 30 and the active material layer 22 by performing the compression process while sandwiching the active material 22c between the separator 30 and the release film 40B. Furthermore, the manufacturing device 3000 can manufacture the single cell 10 by supplying the active material layer 22 of another pole and the current collector layers of both poles to the member.

Although the fourth embodiment has been described above in detail with reference to the figures, the specific configuration is not limited to these embodiments. This invention also includes modifications, combinations, deletions, etc. of the configuration without departing from the gist of the present invention. Furthermore, it is needless to say that the configurations shown in each embodiment can be used in appropriate combinations. For example, in the third embodiment, the frame member supply device 3200 may be arranged in the downstream side D1 from the active material supply device 3300. In other words, after the active material 22c is supplied onto the current collector 21B, the frame member 35 may be supplied onto the current collector 21B. In this case, the frame member supply device 3200 supplies the frame member 35 onto the current collector 21B so that the active material 22c, which has been supplied onto the current collector 21B, enters the internal space of the frame member 35. With this configuration, the frame member 35 can be supplied onto the current collector 21B after the active material 22c is supplied onto the current collector 21B. Alternatively, a mask may be formed on the current collector 21B before the frame member 35 is supplied to the current collector 21B, and the frame member 35 may be supplied at the position of the mask at an arbitrary timing thereafter. Alternatively, the manufacturing device 3000 may not comprise the frame member supply device 3200.

What is claimed is:

1. A battery electrode manufacturing device comprising:
a film supply unit that supplies a film to an active material, wherein the active material has been stacked on a strip-shaped base film, wherein the active material is conveyed along a conveying direction in a chamber whose interior is decompressed below atmospheric pressure; and
a compression unit that compresses the active material, which has been supplied on the base film, via the film.

2. The battery electrode manufacturing device according to claim 1, further comprising:
a separator supply unit that supplies a separator to the active material, which is conveyed, as the film supply unit,
wherein the compression unit compresses the active material, which has been supplied on the base film, via the separator.

3. The battery electrode manufacturing device according to claim 2,
wherein the base film is a current collector,
wherein the active material contains an electrolytic solution,
wherein the compression unit causes the electrolytic solution to soak into the separator from the active material by sandwiching and compressing the strip-shaped current collector, the active material, and the separator.

4. The battery electrode manufacturing device according to claim 3,
wherein the electrolytic solution is contained in a resin layer that is provided on each particle of the active material.

5. The battery electrode manufacturing device according to claim 2, further comprising:
a post-processing device that executes a post-processing containing at least one of heat-sealing and shaping/cutting to the separator after the separator has been compressed by the compression unit.

6. The battery electrode manufacturing device according to claim 5,
wherein the post-processing device executes the post-processing while moving along the conveying direction in synchronization with the movement of the active material and the separator that are conveyed along the conveying direction.

7. The battery electrode manufacturing device according to claim 1, further comprising:
a release film supply unit that supplies a release film to the active material, which is conveyed, as the film supply unit,
wherein the compression unit compresses the active material, which has been supplied on the base film, via the release film.

8. The battery electrode manufacturing device according to claim 7, further comprising:
a release film collecting unit that peels the release film, which has been compressed by the compression unit, from the active material.

9. The battery electrode manufacturing device according to claim 8,
wherein the base film is a current collector,
wherein the current collector and the active material correspond to a first electrode side, which is one of a cathode or an anode,
the battery electrode manufacturing device further comprising:
a combining unit that combines another pole member sheet with the active material and the current collector after being compressed by the compression unit so that the separator and the active material layer are in contact with each other,
wherein said another pole member sheet comprises another pole current collector corresponding to a second electrode side that is different from the first electrode side, another pole active material corresponding to the second electrode side that has been stacked on said another pole current collector, and a separator that has been stacked on said another pole active material.

10. The battery electrode manufacturing device according to claim 2,
wherein the base film is a current collector,
wherein the separator supply device supplies the separator by overlapping a strip-shaped separator sheet to the active material, which is conveyed, while conveying the strip-shaped separator sheet along the conveying direction, and
wherein the compression unit comprises a plurality of rotating rollers and a ring member, which is driven by the plurality of rotating rollers, and compresses the active material via the separator in a state where the ring member and the separator are in contact with each other.

11. The battery electrode manufacturing device according to claim 10,
wherein the compression unit comprises a first roller and a second roller that is a pair of the first roller, wherein the first roller and the second roller are included in the plurality of rotating rollers,
wherein the first roller and the second roller sandwich and compress the current collector, the active material, and the separator in a state where the ring member is located between the first roller and the separator,
wherein the compression unit further comprises a third roller, which is included in the plurality of rotating rollers, located upstream along the conveying direction from the first roller, and
wherein the separator is conveyed to the position of the first roller and is compressed by being sandwiched between the first roller and the second roller together with the ring member, the current collector, and the active material, after the separator contacts the ring member at the position of the third roller.

12. The battery electrode manufacturing device according to claim 10, further comprising:
a reinforcing sheet that is located on the first surface of the separator,
wherein the compression unit sandwiches and compresses the current collector, the active material, and the separator in a state where the active material and the reinforcing sheet are in contact with each other.

13. The battery electrode manufacturing device according to claim 10, further comprising:
a first reinforcing sheet that is provided on the first surface of the separator; and
a second reinforcing sheet that is provided on the second surface opposite the first surface,
wherein the compression unit sandwiches and compresses the current collector, the active material, and the separator in a state where the active material and the first reinforcing sheet are in contact with each other, and the ring member and the second reinforcing sheet are in contact with each other.

14. The battery electrode manufacturing device according to claim 10, further comprising:
irregularities that are formed on the side of the ring member, wherein said side is in contact with the separator.

15. A battery electrode manufacturing method including:
a film supply step of supplying a film to an active material, wherein the active material has been stacked on a strip-shaped base film, wherein the active material is conveyed along a conveying direction in a chamber whose interior is decompressed below atmospheric pressure; and
a compression step of compressing the active material, which has been supplied on the base film, via the film.
